(19) United States
(12) Patent Application Publication
(10) Pub. No.: US 2026/0166823 A1
(43) Pub. Date: Jun. 18, 2026

(54) METHOD FOR PRODUCING A LINER MADE OF FIBER-REINFORCED POLYMER MATERIAL

(71) Applicant: SKF Aerospace France S.A.S, Perrigny (FR)

(72) Inventors: Anthony Roger Jeannot JÉRÔME, TOURNON-SUR-RHONE (FR); Eric Jean-Marie DENEUX, Metz (FR); Stéphane LEBERCHE, Commenailles (FR); Florent Denis FAUCHERY, Montmeyran (FR)

(21) Appl. No.: 19/416,215

(22) Filed: Dec. 11, 2025

(30) Foreign Application Priority Data
Dec. 18, 2024 (FR) FR2414416

(51) Int. Cl. B29C 70/32; B29C 70/54; B29K 27/18; B29K 105/08; B29K 307/04; B29K 309/08

(52) U.S. Cl. CPC B29C 70/32; B29C 70/545; B29K 2027/18; B29K 2105/089; B29K 2307/04; B29K 2309/08

(57) ABSTRACT

A method for producing at least one fiber-reinforced polymer liner having a portion that lies on a sphere or on a cylinder includes winding at least one fiber around a mandrel to form a lay-up on the mandrel, the lay-up comprising a layer of wound fibers or a plurality of layers of wound and superimposed fibers, removing the lay-up formed from the mandrel, and cutting the lay-up before or after removal from the mandrel. Also, optionally, installing the liner in an opening in a housing, the opening having a spherical surface portion.

### CROSS-REFERENCE

This application claims priority to French patent application no. FR2414416 filed on Dec. 18, 2024, the contents of which are fully incorporated herein by reference.

### TECHNOLOGICAL FIELD

The present disclosure relates, in general, to the production of liners intended to be affixed to the surface of a component or the surface of a component portion of non-deployable shape, such as a spherical surface, for example a ball joint or the housing for a ball joint.

More specifically, the disclosure relates to a method for producing a liner made of polymer reinforced with one or more fibers, in particular comprising at least one portion of cylindrical or spherical shape or at least one portion having the shape of a segment of a cylinder or a portion of a sphere.

### BACKGROUND

Conventionally, in the aeronautical field, connectors such as fittings are used. Such connection components serve to connect two members in relative swiveling motion by way of a ball joint interposed between the members and rigidly secured to the connection component. This is the case for example of a fitting for attaching a thrust reverser cowl of an aircraft turbine.

It is known practice to provide a liner, also referred to as a coating, between the ball joint and the housing of the body in which the ball joint is mounted. Such a coating makes it possible to reduce the impact of the loads repeatedly generated during swiveling.

Typical prior art liners include a woven fiber fabric combined with a polymer binder to form a composite that may be affixed to the surfaces of bearings. However, given the spherical shape of the ball joint, the liner must also have a spherical shape.

It is known practice to produce these fabric liners from sheets which are formed by a layer of woven fibers or a flat stack of layers of woven fibers which are bound by a polymer. The sheets are pleated, folded or even partially cut to give them the shape of the liner to be produced. However, pleating the sheets results in mechanical weaknesses, something which greatly impairs the performance of the liner by reducing its mechanical strength properties. Moreover, such shaping of the sheets is complex, which hinders automation and industrialization.

### SUMMARY

The disclosure therefore aims to overcome these drawbacks and to provide a simple method for producing a liner made of composite material with a fiber-reinforced polymer matrix of non-deployable shape, in particular a cylindrical or spherical shape, which retains the mechanical properties of the liner.

A method for producing at least one liner made of polymer reinforced with one or more fibers, in particular comprising at least one portion of cylindrical or spherical shape or of a portion of a cylinder or a portion of a sphere, is therefore proposed, characterized in that it comprises the following steps: at least one step of winding at least one fiber around a mandrel in order to form on the mandrel a lay-up comprising a layer of wound fibers or a plurality of layers of wound and superimposed fibers, at least one step of removing the lay-up from the mandrel, and at least one step of cutting of the lay-up before or after removal from the mandrel.

Such a production method based on filament winding makes it possible to obtain a composite liner with a fiber-reinforced polymer matrix having a non-deployable complex shape, such as cylindrical or spherical, while preserving its mechanical strength properties.

Such a production method becomes faster, reproducible and industrializable.

In one embodiment, the fiber wound around the mandrel may be pre-impregnated with a thermosetting material, the method further comprising a step of polymerizing the lay-up obtained.

In another embodiment, the fiber wound around the mandrel may be partially pre-impregnated with a thermosetting material, or not impregnated with a thermosetting material, the method further comprising: after removal of the lay-up from the mandrel, a step of adding thermosetting material to the lay-up, and a step of polymerizing the lay-up obtained.

When the fiber is a fiber pre-impregnated, partially pre-impregnated or not impregnated with a thermosetting material, one or more preforms may be obtained at the end of the step of cutting of the lay-up. According to one aspect, the liner to be produced may be obtained directly at the end of the preform polymerization step. In another embodiment, the fiber wound around the mandrel may be pre-impregnated with a thermoplastic.

When the fiber is a fiber pre-impregnated with a thermoplastic, one or more preforms may be obtained at the end of the step of cutting of the lay-up. According to one feature, the liner to be produced may be obtained directly from the preforms. Alternatively, the production method may comprise at least one folding step to give the preform a final shape and obtain the liner to be produced, in particular an annular shape. The annular liner may be cylindrical or spherical.

Advantageously, one or more notches may be formed on edges of the preforms obtained at the end of the step of cutting of the lay-up to facilitate folding of each of the preforms into the final shape of the liner to be produced.

Preferably, the angle formed between the axis of the mandrel and the fibers in the same layer of fibers of the lay-up is between 50 and 90°, preferably between 70 and 90°, more preferably between 80 and 90°. Alternatively, the angle formed between the axis of the mandrel and the fibers in the same layer of fibers of the lay-up may be between 0 and 40°, preferably between 0 and 20°, more preferably between 0 and 10°.

Advantageously, the fiber may be wound around a cylindrical mandrel of diameter equal to the diameter of a cylindrical or spherical portion of the liner to be produced.

According to one feature, the lay-up may be cut helically.

In one embodiment, the fiber may be wound around a mandrel having one or more spherical portions.

Advantageously, the production method may comprise the addition of at least one additional lay-up or liner made of fiber-reinforced polymer to the lay-up obtained. Preferably, the additional lay-up or liner is produced as described above. More preferably, the additional lay-up or liner comprises fibers of a nature different from the fibers of the lay-up obtained on which the addition is made.

In one embodiment, the fiber may be wound on a woven fabric placed between the fiber and the mandrel, the woven fabric being formed of one or more fibers partially or fully pre-impregnated with a thermosetting or thermoplastic polymer or formed of one or more fibers not impregnated with polymer.

In one embodiment, the lay-up obtained may comprise a plurality of layers of wound and superimposed fibers of different natures, preferably comprising at least one layer of fibers consisting of polytetrafluoroethylene (PTFE) fibers and carbon and/or glass fibers and at least one layer of fibers consisting of carbon and/or glass fibers.

### BRIEF DESCRIPTION OF THE DRAWINGS

Further aims, advantages and features will become apparent from the following description, which is given purely by way of illustration and with reference to the appended drawings, in which:

FIG. 1 is a perspective view of a fitting according to an embodiment of the disclosure.

FIG. 2 is a view in transverse cross section of the fitting shown in FIG. 1.

FIG. 3 is a detailed view of the liner of the fitting shown in FIG. 2.

FIG. 4A is a flow chart showing a method for producing a liner made of fiber-reinforced thermosetting material according to an embodiment of the disclosure.

FIG. 4B is a flow chart showing a method for producing a liner made of fiber-reinforced thermoplastic according to another embodiment of the disclosure.

FIG. 5 shows a filamentary winding step of a method for producing a liner according to an embodiment of the disclosure.

FIG. 6 shows a cutting step according to an embodiment of the disclosure.

FIG. 7 shows a cutting step according to another embodiment of the disclosure.

FIG. 8 shows a preform comprising notches according to an embodiment of the disclosure.

FIG. 9 shows a filamentary winding step according to another embodiment of the disclosure.

FIG. 10 shows a filamentary winding step according to another embodiment of the disclosure.

FIG. 11 shows a cutting step according to another embodiment of the disclosure.

FIG. 12 shows a filamentary winding step according to another embodiment of the disclosure.

FIG. 13 shows a filamentary winding step according to another embodiment of the disclosure.

FIG. 14 shows a filamentary winding step according to another embodiment of the disclosure.

FIG. 15 shows the addition of an additional lay-up or liner according to an embodiment of the disclosure.

### DETAILED DESCRIPTION

Below, the limits of a range of values are included in this range, in particular when the term “between” is used. Moreover, the expression “at least one” used in the present description is equivalent to the expression “one or more”.

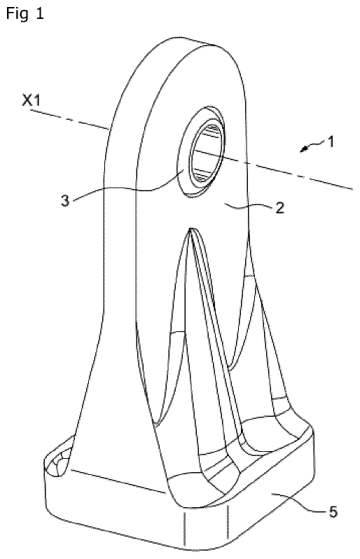

FIG. 1 depicts a connector 1 intended to connect first and second members (not shown). In the example illustrated, the connector is a fitting intended for an application in the aerospace field. The connector 1 comprises a body 2 and a ball joint 3 mounted in a housing 4 of the body 2. The housing 4, of axis X1, is delimited by an inner surface, or bore of the body 2, which is spherical so as to interact with the ball joint 3. The ball joint 3, of axis X2, is able to move by swiveling in the housing 4 of the body 2.

Advantageously, the ball joint 3 has a spherical outer surface 3a intended to interact with the housing 4 for the articulation of the ball joint 3, and an inner surface or bore 3b for fastening the second member. In the example illustrated, the bore 3b is cylindrical and has an axis X2. The ball joint 3 may be formed of two parts that may be separated in order to allow the ball joint 3 to be mounted in the housing 4.

The connector 1 thus makes it possible to rigidly connect the first and second members while at the same time allowing them to be articulated to each other, by swiveling of the ball joint 3 in the housing 4.

The body 2 of the connector 1 further comprises a fastening zone for the first member to

be connected, which, in the example illustrated, takes the form of a base 5. Means for fastening the first member to the connector 1 may involve screws or rivets. Advantageously, the body 2 may be made of composite material having reinforcing fibers embedded in a plastic matrix. Advantageously, the fibers are, for example, made of carbon or glass. Preferably, the plastic matrix is a thermosetting resin, for example epoxy, but other materials such as thermoplastic resins, for example PEEK, PEKK, PEAK, may be used. Advantageously, the ball joint 3 may be made of metal, for example of titanium, steel, aluminum, bronze or an alloy of these.

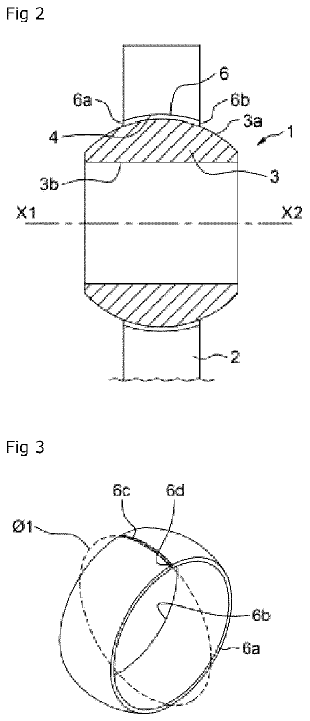

With reference to FIGS. 2 and 3, the connector 1 also comprises a liner 6 made of fiber-reinforced polymer, interposed between the housing 4 of the body 2 and the ball joint 3.

In the present disclosure, the term “liner” means a fibrous strip, or coating, formed of one or more layers of fibers impregnated with polymer material.

The liner 6 shown is of annular shape, formed by a segment of a sphere of diameter Ø1, and comprising two opposite circular lateral edges 6a and 6b. In the example illustrated, the liner 6 is obtained by cutting a lay-up 7 and has two ends 6 c and 6 d positioned facing each other to form a ring.

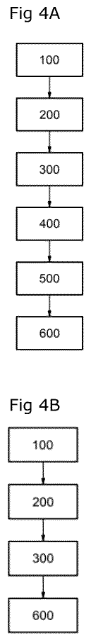

FIG. 4A depicts a method for producing the liner 6 according to an embodiment according to which the polymer of the liner 6 made of composite material with a fiber-reinforced polymer matrix produced is a thermosetting material. With reference to FIG. 5, the production method comprises a step of winding 100 a fiber around a mandrel M to form a lay-up 7 on the mandrel M. The mandrel M is circular and straight cylindrical.

The lay-up 7 formed may comprise a plurality of layers of fibers wound and superimposed on one another. Alternatively, the lay-up 7 may comprise a single layer of wound fibers. In the example illustrated, the fiber wound around the mandrel M is a flat fiber forming a strip. According to an alternative, several fibers may be wound simultaneously around the mandrel M.

Each fiber is initially prewound on a head. In order to carry out the filament winding, the mandrel M is rotated about the axis Y thereof. An initial sub-step of winding of the pre-impregnated fibers around the mandrel M allows a first layer to be formed around the mandrel M. This first layer is formed with the mandrel M rotating about the axis Y thereof and the heads which support the fibers moving parallel to the axis Y. Subsequently, a succession of sub-steps of winding of the fibers allows the lay-up 7 to be formed by superimposition of layers one on the other around the mandrel M.

Advantageously, the step 100 of winding of the fibers around the mandrel M may be controlled by computer and thus automated.

For example, the fibers may be glass fibers, carbon fibers, Kevlar® fibers or any other suitable material. Advantageously, a plurality of layers of fibers of different natures may be wound and superimposed around the mandrel M.

According to one embodiment, the lay-up 7 produced may comprise a first side formed by at least one layer of polytetrafluoroethylene (PTFE) fibers and carbon and/or glass fibers, and a second opposite side formed by at least one layer of carbon and/or glass fibers. The first side of the liner 6, which includes fibers with structuring properties, may be placed in contact with the housing 4, and the second side of the liner 6, which comprises fibers with lubricating properties, may be placed in contact with the ball joint 3.

The thermosetting material of the liner 6 made of fiber-reinforced thermosetting material produced is, for example, an epoxy resin. The fiber wound around the mandrel M may be a fiber pre-impregnated with a thermosetting material.

In a cutting step 200, the lay-up 7 obtained at the end of the step of filament winding 100 is cut.

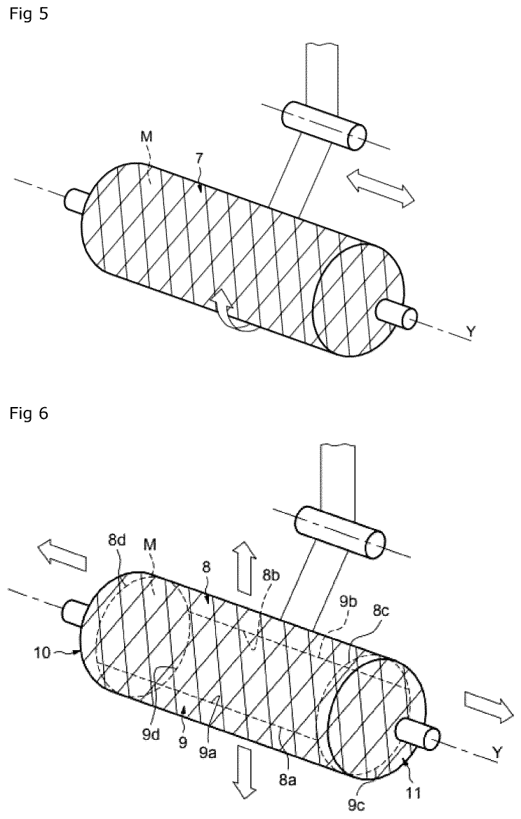

In the example illustrated in FIG. 6, the lay-up 7 is cut in two axial directions relative to the axis of the mandrel M so as to form two preforms 8 and 9 each forming a half-cylinder. Each preform 8 and 9 is intended to form a liner 6. The preforms 8 and 9 obtained at the end of the cutting step 200 are removed from the mandrel M in a removal step 300. The two ends 10 and 11 of the lay-up 7 are also cut by cutting in a radial direction and are then removed.

According to one feature, the mandrel M may, for example, be a fusible or inflatable mandrel. Alternatively, the mandrel M may be removed before the step of cutting 200 the lay-up 7.

When the liner 6 produced is made of a composite with a fiber-reinforced thermosetting matrix, the production method further comprises a step of polymerization 500 of the thermosetting material of the preforms 8 and 9 obtained. According to one feature, the polymerization step may be carried out in a mold. The preforms 8 and 9 are then removed from the mold after polymerization.

Alternatively, the fiber wound around the mandrel M may be partially pre-impregnated with thermosetting material, this being referred to as powdered fiber, or not impregnated with thermosetting material. The production method then comprises an additional step of adding 400 thermosetting material. According to one example, the fiber partially pre-impregnated with thermosetting material may comprise a content of between 1 and 4% by weight of the thermosetting material content of the fiber impregnated with thermosetting material at the end of the additional addition step 400. Preferably, the additional step of adding 400 thermosetting material is carried out after cutting the lay-up 7 of the mandrel M, on the preforms 8 and 9, more preferably after removing the mandrel M.

FIG. 4B depicts a method for producing the liner 6 according to another embodiment according to which the thermosetting material of the liner 6 is replaced with a thermoplastic material. The fiber wound around the mandrel M is pre-impregnated with a thermoplastic.

Advantageously, the production method comprises a step of folding 600 the preforms 8, 9 obtained after cutting the lay-up 7 to give them the final shape of the liner 6 to be produced. In the example illustrated, the final shape of the liner 6 is spherical annular.

In the example illustrated in FIG. 6, each of the preforms 8 and 9 of semi-cylindrical shape is folded up on itself in such a way as to join its two ends 8c and 8d, 9c and 9d and form the spherical liner 6 visible in FIG. 3. Two liners 6 are thus obtained.

The two ends 8c and 8d, 9c and 9d of each of the preforms 8 and 9 are intended to form the two ends 6c and 6d of the liner 6, and the two lateral edges 8a and 8b, 9a and 9b of each of the preforms 8 and 9 are intended to form the two lateral edges 6a and 6b of the liner 6.

According to one alternative, the lay-up 7 may be cut in such a way as to form a number greater than two preforms each forming a half-cylinder, in particular by additional cuts in radial directions. Each half-cylinder forms a preform intended to form a liner 6.

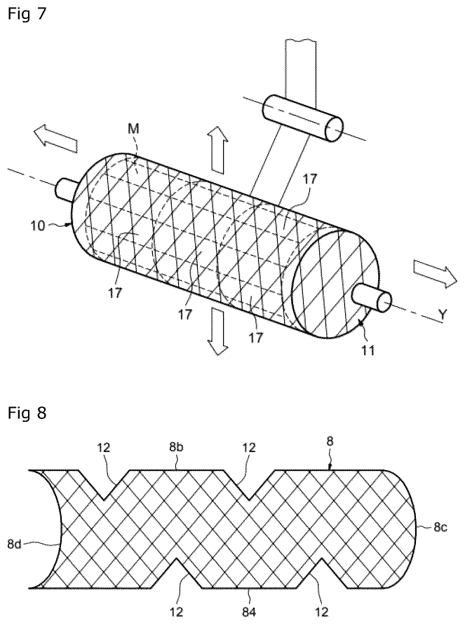

According to another alternative shown in FIG. 7, and in order to reduce the volume of off-cuts, the lay-up 7 may be cut in such a way as to form a plurality of cylindrical segments 17, in particular by a plurality of cuts in radial directions and a plurality of cuts in axial directions relative to the axis Y of the mandrel M. Each cylindrical segment forms a preform intended to form a liner 6.

When the polymer matrix is a thermosetting matrix, the folding step 600 is preferably carried out before the polymerization step 500.

When the fiber wound around the mandrel M is a fiber partially pre-impregnated with thermosetting material or not impregnated with thermosetting material, the folding step 600 may be carried out before or after the addition of thermosetting material.

As shown in FIG. 8, notches 12 may advantageously be formed on the two opposite lateral edges 8a, 8b and 9a, 9b of the preforms 8 and 9 in order to facilitate the folding thereof into the final shape of the liner 6. Advantageously, each notch 12 may be made by cutting and removing a triangular portion from the lateral edges 8c, 8d, 9c, 9d of the preforms 8, 9. The notches 12 make it easier to shape the preforms 8 and 9 to the final shape of the liner 6, by limiting bending of the fibers so as to better preserve the mechanical properties of the liner 6.

In order to limit damage to the network of fibers from cutting the fibers, they are cut in such a way that the angle of each triangular portion cut corresponds to the angle formed between the fibers and such that the sides of the triangular portions extend parallel or perpendicular to the fibers.

In one embodiment, and with reference to FIG. 9, the diameter of the mandrel M is preferably equal to the diameter Ø1 of the sphere formed by the liner 6 to be produced, visible in FIG. 3. It is thus possible to reduce the creasing of the fibers that occurs on the preform 8, 9 during the folding step 600 and thus to even better preserve the final mechanical properties of the liner 6.

Alternatively, the diameter of the mandrel M may be equal to the diameter of the annular portion formed by the liner 6 to be produced.

Unlike a textile fabric liner formed of woven fibers which intersect only at right angles, the angle formed between the fibers of the liner 6 produced using the production method according to the disclosure may be adjusted. Advantageously, the winding step 100 may be carried out in such a way that the angle formed between the axis Y of the mandrel M and the fibers, in at least one layer of fibers of the lay-up 7, preferably in all the superimposed layers of fibers, is between 50° and 90°. Preferably, the angle is between 70° and 90°, and more preferably between 80° and 90°. Such ranges of values are particularly advantageous for preventing delamination of the liner 6 of the fitting 1.

In the example illustrated, the liner 6 produced from the lay-up 7 is intended to be integrated between the ball joint 3 and the housing 4 of the fitting 1.

FIG. 10 shows a first layer of fiber wound around the mandrel M and close to the circumference of the mandrel M.

The more the fibers extend in a plane close to the circumference of the mandrel M, the more easily the preforms 8, 9 may be folded without creasing the fibers, especially when the two ends of each preform 8, 9 are brought together to obtain the annular-shaped liner 6.

In the example shown, the combination between an angle formed between the axis Y of the mandrel M and the fibers of between 50 and 90° and a diameter of the mandrel equal to the diameter of the sphere of the liner 6 to be produced is particularly advantageous for preserving the mechanical properties of the liner 6.

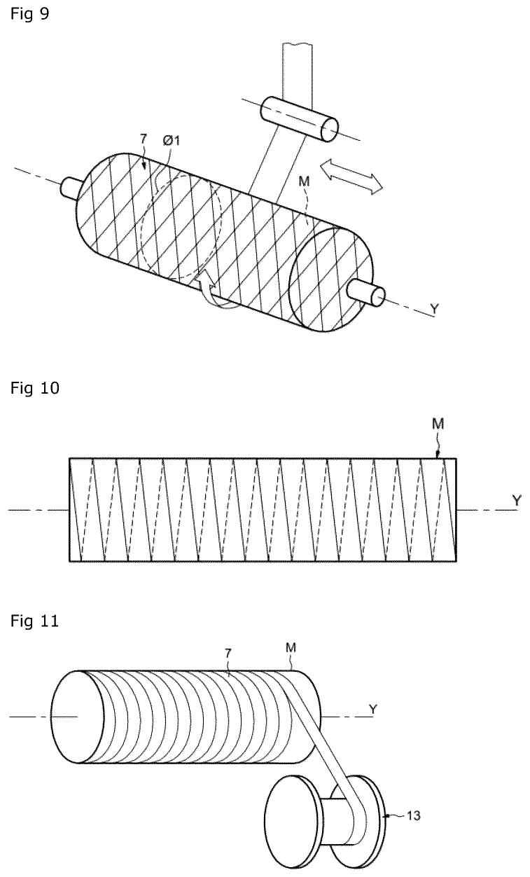

In the examples shown in FIGS. 6 and 7, the lay-up 7 is cut in longitudinal and radial directions, in other words parallel or perpendicular to the axis Y of the mandrel M. Alternatively, the lay-up 7 may be cut helically about the axis Y of the mandrel M for mass production of a liner, as shown in FIG. 11. In this case, the helical preform resulting from the helical cut may be sliced into multiple liners. The cut lay-up may be wound around a reel 13.

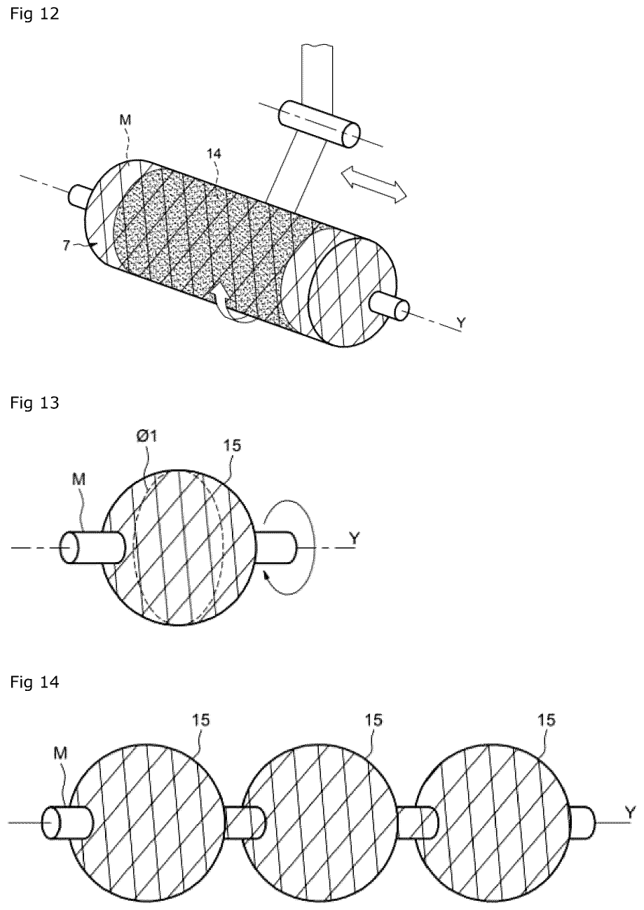

According to another embodiment, the fiber may be wound on a woven fabric 14 shown in FIG. 12, placed between the fiber and the mandrel M, in contact with the mandrel M. The woven fabric 14 may be formed of one or more fibers partially or fully pre-impregnated with a thermosetting or thermoplastic polymer material or formed of one or more fibers not impregnated with polymer. The liner 6 obtained comprises the lay-up 7 formed by filament winding and the woven fabric 14. Such an addition of the woven fabric 14 makes it possible to add, for example, fibers of different natures and new properties to the lay-up 7 produced by filament winding.

Advantageously, the production method may comprise a heating step after the step of winding 100 around the mandrel M or after the step of adding 400 thermosetting material so that the polymer material of the impregnated fibers of the lay-up 7 sticks to the woven fabric 14 to form cohesion.

In another embodiment shown in FIG. 13, the fiber may be wound around a mandrel M comprising a spherical portion 15 of diameter Ø1. Preferably, the mandrel M is a fusible or inflatable mandrel so as to preserve the integrity of the spherical portion 15. The lay-up 7 may be cut on the edges of the spherical portion to give it the final annular shape of the liner 6.

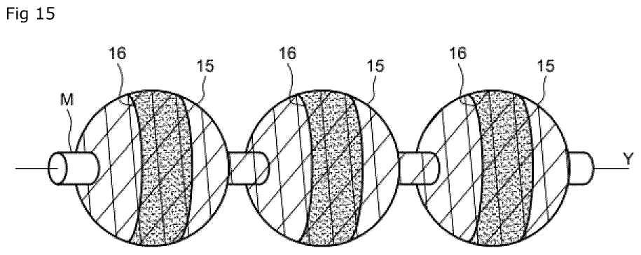

Advantageously, the mandrel M may comprise a plurality of spherical portions 15 of diameter Ø1 in order to produce a plurality of liners 6 in a single operation, as shown in FIG. 14. Advantageously, at least one additional lay-up or liner 16 made of fiber-reinforced polymer may be added to the lay-up 7 obtained to form a patch, as shown in FIG. 15. The additional lay-up or liner 16 makes it possible to add, for example, fibers of different natures and new properties to the lay-up 7. Advantageously, the additional lay-up or liner 16 is produced according to a production method as described above. According to one example, the additional lay-up or liner 16 comprises fibers of a nature different from the fibers of the lay-up 7 obtained on which the addition is made.

The liner may be attached to the ball joint or, preferably, to the housing 4 of the body 2 of the connector 1. In one embodiment, the liner may be attached to the housing 4 of the body 2 by impregnation of the polymer matrix between the body 2 and the liner 6. Preferably, the polymer matrix of the liner 6 and the polymer matrix of the body 2 are identical in order to improve the cohesion between the liner 6 and the body 2.

In another embodiment, the liner 6 may be attached in contact with the housing 4 or the ball joint 3 by means of an adhesive.

In the embodiment described, the liner produced by the production method according to the disclosure is a liner for a fitting. The disclosure is not limited to such a use and may be applied to the production of a liner for another type of plain bearing other than a fitting, for example a rod end or a shackle.

Moreover, the disclosure is not limited to the field of aerospace and may be applied to any other technical field.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved methods for producing liners.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A method for producing at least one fiber-reinforced polymer liner having a portion that lies on a sphere or on a cylinder, the method comprising,
winding at least one fiber around a mandrel to form a lay-up on the mandrel, the lay-up comprising a layer of wound fibers or a plurality of layers of wound and superimposed fibers,
removing the lay-up formed from the mandrel, and
cutting the lay-up before or after removal from the mandrel.

2. The method according to claim 1, including:
providing a connector having an opening having a spherical surface portion,
after removing the lay-up from the mandrel, installing the lay-up in the opening on the spherical surface portion, and
after installing the lay-up, mounting a ball joint in the opening with a surface of the ball joint in contact with the lay-up.

3. The method according to claim 1,
wherein the at least one fiber is pre-impregnated with a thermosetting material, and
wherein the method further comprises polymerizing the lay-up.

4. The method according to claim 1, further comprising:
after removing the lay-up from the mandrel, adding a thermosetting material to the lay-up, and
after adding the thermosetting material, polymerizing the lay-up.

5. The method according to claim 1, wherein the at least one fiber is pre-impregnated with a thermoplastic.

6. The method according to claim 1,
wherein an angle formed between an axis of the mandrel and the fibers in a given layer of the fibers is between 50° and 90°.

7. The method according to claim 1,
wherein an angle formed between an axis of the mandrel and the fibers in a given layer of the fibers is between 70° and 90°.

8. The method according to claim 1,
wherein an angle formed between an axis of the mandrel and the fibers in a given layer of the fibers is between 80° and 90°.

9. The method according to claim 1,
wherein cutting the lay-up comprises cutting the layup helically.

10. The method according to claim 1, wherein the mandrel includes a spherical portion.

11. The method according to claim 1,
wherein the at least one fiber comprises a fiber formed from a first material,
the method further comprising winding at least one fiber formed from a second material different than the first material on top of the at least one first fiber.

12. The method according to claim 10,
wherein the first material comprises polytetrafluoroethylene and the second material comprises carbon fibers and/or glass fibers.

13. The method according to claim 1,
including, before winding the at least one fiber around the mandrel, placing a layer of woven fabric on mandrel and
wherein the winding at least one fiber around a mandrel comprises winding the at least one fiber around the layer of woven fabric on the mandrel.

14. The method according to claim 13, including:
providing a connector having an opening having a spherical surface portion,
after removing the lay-up from the mandrel, installing the lay-up in the opening on the spherical surface portion, and
after installing the lay-up, mounting a ball joint in the opening with a surface of the ball joint in contact with the lay-up.

15. The method according to claim 14,
wherein an angle formed between an axis of the mandrel and the fibers in a given layer of the fibers is between 80° and 90°.

16. The method according to claim 15,
wherein the first material comprises polytetrafluoroethylene and the second material comprises carbon fibers and/or glass fibers.
